(19) United States
(12) Patent Application Publication
(10) Pub. No.: US 2004/0115561 A1
(43) Pub. Date: Jun. 17, 2004

(54) Energy curable, water washable printing inks suitable for waterless lithographic printing

(76) Inventors: Mikhail Laksin, Scotch Plains, NJ (US); Hugo Babij, Waldwick, NJ (US); Paul J. Sirotto, Little Falls, NJ (US)

Correspondence Address: Sun Chemical Corporation, 222 Bridge Plaza South, Fort Lee, NJ, 07024, US

(21) Appl. No.: 10/319,061

(22) Filed: Dec. 13, 2002

(51) Int. Cl. G03C 1/73; G03C 1/725

(52) U.S. Cl. 430/285.1; 430/287.1; 430/906

(57) ABSTRACT

Energy curable varnish and energy curable, water washable printing ink compositions suitable for waterless lithographic printing are disclosed each containing: water soluble ethylenically unsaturated reactive oligomers and monomers; water insoluble ethylenically unsaturated reactive oligomers and monomers; and a resin selected from water soluble non-reactive resins, a water insoluble acid or base functional resins and water insoluble ethylenically unsaturated reactive resins, wherein said water insoluble resins contain acid functional groups.

### FIELD OF THE INVENTION

This invention relates to energy curable printing inks suitable for waterless lithographic printing that can form a water resistant or a water insoluble printed image, yet are water washable before curing when being removed from ink trains such as rollers and offset blankets of the printing press.

### BACKGROUND OF THE INVENTION

The use of single phase (i.e., “waterless” or without the need for fountain solution) water based inks (as opposed to oil based inks) in offset lithographic printing is known and described in U.S. Pat. No. 5,725,646 and U.S. Pat. No. 5,778,789. These water based ink compositions eliminated the principal disadvantages of conventional offset lithographic printing inks, such as high levels of VOCs emanating from the oil based ink and the aqueous fountain solution and the difficulty in controlling the ink/water balance, while preserving the principal advantage of the conventional lithographic printing process, i.e., high surface energy differential between the image and non-image areas of the printing plate.

This solution, however, is not very effective on all types of printing press configurations. Specifically, an extended inking system with a large number of rollers would require higher humectant concentrations to achieve the desired ink's tack stability. Also, the presence of the latex in the ink compositions of the prior art may have detrimental effect on gloss. Since the ink delivery system on the press can contain up to 13 distribution rollers, tack stability is very important.

Thus, there is a need in the art for an energy curable, water washable printing ink composition usable in the waterless lithographic process that is stable on conventional ink trains and exhibits good optical printing density and water resistance to the final film without increasing the tack of the formulation, thereby allowing for its use on high speed presses.

The main benefit of energy curable inks is that they are extremely stable on rollers since no loss of solvent or water takes place. Energy curable inks are also very low in VOC's. They have excellent film properties and are widely used to produce high quality prints.

A combination of no fountain solution (waterless lithography), low VOC energy curable inks and water washability on printers before curing (low VOC washes) could combine to give high performance, very low VOC inks that are desirous under current conditions in the market.

### SUMMARY OF THE INVENTION

The present invention provides an energy curable, varnish composition comprising: (a) water soluble ethylenically unsaturated reactive oligomers and monomers; (b) water insoluble ethylenically unsaturated reactive oligomers and monomers; and (c) a resin selected from the group consisting of a water soluble non-reactive resin, a water insoluble acid or base functional resin and water insoluble ethylenically unsaturated reactive resin, wherein said water insoluble resins contain acid functional groups.

The present invention also provides an energy curable, water washable, printing ink composition suitable for waterless lithographic printing comprising: (a) water soluble ethylenically unsaturated reactive oligomers and monomers; (b) water insoluble ethylenically unsaturated reactive oligomers and monomers; (c) a resin selected from the group consisting of a water soluble non-reactive resin, a water insoluble acid or base functional resin and water insoluble ethylenically unsaturated reactive resin, wherein said water insoluble resins contain acid functional groups; and (d) a pigment.

The present invention further provides a method of preparing an energy curable, water washable, printing ink composition suitable for waterless lithographic printing comprising mixing: (a) water soluble ethylenically unsaturated reactive oligomers and monomers; (b) water insoluble ethylenically unsaturated reactive oligomers and monomers; (c) a resin selected from the group consisting of a water soluble non-reactive resin, a water insoluble acid or base functional resin and water insoluble ethylenically unsaturated reactive resin, wherein said water insoluble resins contain acid functional groups; and(d)a pigment.

The present invention also provides a method of waterless lithographic printing comprising using an energy curable, water washable, printing ink composition which comprises: (a) water soluble ethylenically unsaturated reactive oligomers and monomers; (b) water insoluble ethylenically unsaturated reactive oligomers and monomers; (c) a resin selected from the group consisting of a water soluble non-reactive resin, a water insoluble acid or base functional resin and water insoluble ethylenically unsaturated reactive resin, wherein said water insoluble resins contain acid functional groups; and (d) a pigment.

Other objects and advantages of the present invention will become apparent from the following description and appended claims.

### DETAILED DESCRIPTION OF THE INVENTION

It has now been found that an energy curable, water washable, printing ink composition suitable for waterless lithographic printing, that is stable on conventional ink trains and exhibits good optical printing density and water resistance to the final film without increasing the tack of the formulation can be prepared in a formulation that comprises: (a) water soluble ethylenically unsaturated reactive oligomers and monomers; (b) water insoluble ethylenically unsaturated reactive oligomers and monomers; (c) a resin selected from the group consisting of a water soluble non-reactive resin, a water insoluble acid or base functional resin and water insoluble ethylenically unsaturated reactive resin, wherein said water insoluble resins contain acid functional groups; and (d) a pigment.

Preferably, the printing ink composition is an energy curable, lithographic printing ink composition and is water-washable before curing and water resistance after curing.

Preferably, the amount of water soluble ethylenically unsaturated reactive oligomers and monomers present is between 30 and 85 parts, the amount of water insoluble ethylenically unsaturated reactive oligomers and monomers is between 10 and 45 parts and the amount of the acid functional groups in the water insoluble resins is about 5 to 25 parts.

Also preferably, the water soluble oligomer is selected from the group consisting of an acrylate oligomer, a methacrylate oligomer, epoxy acrylate, an epoxy methacrylate, a polyether acrylate, a polyether methacrylate, a polyester acrylate, a polyester methacrylate, a polyurethane acrylate, a polyurethane methacrylate, a melamine acrylate, or a melamine methacrylate. Typically the acrylate is an aromatic or aliphatic acrylate or methacrylate and preferably the compound is a diacrylate ester of an alkanolglycidyl ether such as 1,4-butanedioldiglycidyl ether, an ethoxylated aromatic epoxide and ethoxylated trimethylolpropane triacrylate, ethoxylated trimethylolpropane trimethacrylate, ethoxylated aliphatic or aromatic epoxy acrylate, ethoxylated aliphatic or aromatic epoxy methacrylate, polyoxyethylene glycol diacrylate; polyoxyethyleneglycol di-methacrylate. Preferably, the ethoxylated aromatic epoxide contains 6 to 20 ethoxy groups. Further, the compounds may contain two or more terminal, or pendent, -ethylenically unsaturated groups which are linked through a polymeric backbone, or through similar linking groups to a central aliphatic or aromatic backbone.

The water soluble oligomer can contain two or more acrylate oligomer groups or methacrylate oligomer groups. Examples of the acrylate oligomer include but are not limited to epoxy acrylate, epoxy methacrylate, polyether acrylate, polyether methacrylate, polyester acrylate, polyester methacrylate, polyurethane acrylate, polyurethane methacrylate, melamine acrylate, melamine methacrylate, polyethylene glycol diacrylate and polyethylene glycol dimethacrylate oligomers.

Suitable water soluble oligomers also include aliphatic and aromatic epoxy acrylates and epoxy methacrylates, aliphatic compounds preferably being employed. These include, for example, the reaction products of acrylic acid or methacrylic acid with aliphatic glycidyl ethers.

Further suitable water soluble oligomers are polyether acrylates and methacrylates, polyester acrylates and methacrylates and polyurethane acrylates and methacrylates. Among these, preference is given to the reaction products of acrylic or methacrylic acid with the polyesterols and polyetherols which were described as polycondensates. Particular preference is given to the radiation curable acrylates described in EP-A-126,341 and EP-A-279,303. Polyetherols employed in this context are preferably alkoxylated, especially ethoxylated and/or propoxylated, mono-, di-, tri- or polyfunctional alcohols.

Other suitable water soluble oligomers are melamine acrylates and methacrylates. These are obtained, for example, by esterifying the free methylol groups of the resins with acrylic acid or methacrylic acid, or by transetherification of etherified melamine compounds with hydroxyalkyl methacrylates, for example hydroxyethyl, hydroxypropyl and hydroxybutyl methacrylate, hydroxybutyl acrylate.

Still further suitable water soluble oligomers are, in general, thickeners which contain unsaturated groups. These include on the one hand polyurethane thickeners, which contain, -ethylenically unsaturated double bonds as a result of the incorporation of the above mentioned hydroxyalkyl methacrylates, hydroxyalkyl acrylates. They also include polyacrylate thickeners, which are obtained by polymer-analogous reaction of, for example, hydroxyl-containing polymers, or polymers containing acid groups, with epoxide-containing methacrylates, acrylates for example glycidyl methacrylate, glycidyl acrylate, or of hydroxyl-containing polymers of esterification with methacrylic acid, acrylic acid or reaction with methacrylic anhydride, acrylic anhydride or by reaction with NCO-terminated methacrylates, methacrylates for example methacryloyl isocyanate, isocyanatoethyl methacrylate, isocyanatoethyl acrylate etc. They additionally include polyvinyl alcohols, which are modified, for example, by reaction with methacrylic anhydride, acrylic anhydride or by esterification with methacrylic acid, acrylic acid with groups containing double bonds. Finally, they include copolymers comprising maleic anhydride as co-monomer, the polymer being modified by ring opening of the anhydride with the above mentioned hydroxyalkyl methacrylates, hydroxyalkyl acrylates or with hydroxy vinyl ethers, for example butanediol monovinyl ether, cyclohexanedimethanol monovinyl ether etc., with double bonds.

Particularly preferred water soluble oligomers include diacrylate esters of an alkanolglycidyl ethers; wherein the alkanol has 2 or 3 hydroxy groups, such as a diacrylate of 1,4-butanedioldiglycidyl ether; a triacrylate of trimethylolpropane-diglycidyl ether, or a mixture thereof; and ethoxylated acrylic oligomers, such as an ethoxylated trimethylolpropanetriacrylate; an ethoxylated trimethylolpropane diacrylate; or a mixture thereof; wherein the ethoxylated oligomer contains 9-12 ethoxy groups. A particularly preferred water soluble oligomer is the diacrylate ester of 1,4-butanedioldiglycidyl ether, which is available from BASF Corporation, Charlotte N.C., as Laromer LR 8765 aliphatic epoxy acrylate.

The water soluble, ethylenically unsaturated resin can contain carboxylic acid groups, acrylic groups including but not limited to methacrylic groups, polyamide resins, acrylic resins, acrylated acrylic resin, amino resins, polyester resins, urethane resins, starch, polysulfonate resins, phenolic resins and melamine resins. In addition to meeting these requirements the polymer of the water soluble, ethylenically unsaturated resin may optionally containing free radical polymerizable functionalities, for example, the class of compounds meeting these requirements would include copolymers of the general structure:

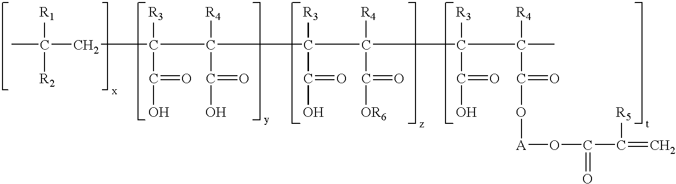

wherein: R₁ and R₂ are independently selected from the group consisting of hydrogen, C₁-C₂₀ alkyl, C₆-C₁₀ aryl, C₇-C₁₄ alkaryl, C₄-C₁₂ cycloalkyl and halogen such as chlorine, fluorine and bromine; and preferably are independently selected from hydrogen, methyl, phenyl, benzyl, or C₄-C₆ cycloalkyl; R₃, R₄ and R₅ are independently selected from the group consisting of hydrogen and C₁-C₅ alkyl; and preferably and independently selected from hydrogen and/or methyl; R₆ is selected from the group consisting of alkyl, aralkyl, alkyl substituted aralkyl and oxyalkylated derivatives of same containing 2 to 4 carbon atoms in each oxyalkylene group, which group may be 1 to 20 and preferably 1 to 6 repeating units; A is a linear or branched divalent C₁-C₂₀ alkylene or oxyalkylated derivative thereof as described in connection with R₆; and subscripts x, y, z and t are whole numbers such that the sum of x, y, z and t ranges from 3 to 20, with each being equal to or greater than 1.

The water soluble, ethylenically unsaturated resin can further contain polyacrylamides, polyamides, polyvinyl alcohol, polyglycols, polyethylene or polypropylene oxide, poly (N-vinyl-4 methyl-2-oxazalidone, polyvinylpyrrolidone, co-polymers of polyvinylpyrrolidone and vinyl acetate, of polyvinyl acetate, guar or xanthan gum, polysaccharides, polyethyleneamine, sodium salt of polyurethane or polyester, polystyrene sodium sulfonate salts, polyacrylic and polymethacrylic acids, carboxylmethyl cellulose or a combination thereof.

The water insoluble, ethylenically unsaturated resin can contain long chain aliphatic resins, aromatic resins, phenol formaldehyde resins, melamine resins, hydrocarbon resins and rosins, or a combination thereof.

The water insoluble, ethylenically unsaturated resin may be a ring opening polymerizable composition, a free radical addition polymerizable composition, or a combination of ring opening and free radical polymerization. When the water insoluble, ethylenically unsaturated resin is a ring opening polymerizable composition, upon energy initiation it forms a polymer typically bound by ester, or ether linkages.

Hence the water insoluble, ethylenically unsaturated resin is a free radical addition polymerizable composition, the water insoluble, ethylenically unsaturated resin comprises a liquid compound having terminal ethylenic unsaturation.

Typically, the water insoluble, ethylenically unsaturated resin is a free radical polymerizable system comprising an ethylenically unsaturated mono- or multi-functional monomer. The monomer is a lower molecular weight ethylenically unsaturated compound which forms a polymer directly upon initiation by free radicals generated by absorbed energy. In some formulations an oligomeric or polymeric component which can be further polymerized may also be present. In such cases the further polymerizable material will be soluble in, or dispersible in the monomer vehicle.

Typically, the monomeric compounds have one, two or more terminal ethylenically unsaturated groups. Representatives of such monomeric compounds are: N-vinyl pyrrolidinone; dipropylene glycol diacrylate; tripropylene glycol diacrylate; butanediol diacrylate; hexanediol diacrylate; trimethylol propane triacrylate; ethoxylated trimethylol propane triacrylate; glycerol-propoxy triacrylate; pentaerythritrol triacrylate; dipropylene glycol dimethacrylate; tripropylene glycol dimethacrylate; butanediol dimethacrylate; hexanediol dimethacrylate; trimethylol propane trimethacrylate; di-(3-methacryloxy-2-hydroxypropyl ether) of bispenol-A; di(2metharyloxyethyl ether) of bisphenol-A; di-(3-acryloxy-2-hydroxypropyl ether) of bisphenol-A; di-(2-acryloxyethyl ether) of bisphenol-A; and the like.

To achieve the desired ink viscosity and cross-linking properties, typically the monomer composition contains a combination of multi-functional acrylic monomers along with a monomer containing a single terminal ethylenic group.

When the inks of this invention contain an oligomeric or polymeric material, said materials typically possess ethylenic unsaturation which can react with the ethylenically unsaturated monomers. Representatives of such oligomers are acrylated epoxy resins; acrylated polyurethanes; acrylated polyesters; and the like.

The water insoluble, ethylenically unsaturated resin may also contain a preferred polymer such as an acrylic polymer or copolymer of C₁-C₄ alkyl acrylates or methacrylates, or acrylic or methacrylic acid, vinyl polymers and copolymers such as polyvinyl chloride, polyvinyl acetate, polyvinyl alcohol; polyvinylpyrolidone; cellulosic polymers and copolymers; and the like.

Preferably, the water used for washing the inks of the present composition before curing has its pH adjusted to be in the basic range, more preferably at a pH of about 8.5. However, when water soluble resin is used in the inks of the present invention, water with about a neutral pH can be used for washing before curing and thus, no pH adjustment is usually required.

The pigment may be one or more of any conventional organic or inorganic pigment selected from the group consisting of Pigment Yellow 1, Pigment Yellow 3, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57:1, Pigment Red 112, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 23, Pigment Black 7, monoazo yellow, monoarylide yellow, diarylide yellow, napthol red, rubine red, lithol rubine, phthalocyanine blue, carbon black, Clariant GDR Pigment Yellow 11-025 (Clariant is a trademark of Clariant Co., Coventry, R.I.) and the like. White pigments such as titanium dioxide, zinc sulfide, zinc oxide may also be used in the inks of this invention. Pigment compositions which are also useful in the inks of this invention are described in U.S. Pat. Nos. 4,946,508; 4,946,509; 5,024,894; and 5,062,894 each of which is incorporated herein by reference. Such pigment compositions are a blend of the pigment along with a poly(alkylene oxide) grafted pigment.

Ink Evaluation

With regard to the evaluation of the print quality using the printing ink compositions of the present invention, it is understood that the ultimate and quintessential goal of any printing is to transfer the ink uniformly onto the printing plate and then onto the printed substrate producing desired image. The main attribute of this image is optical density (print density). While print density requirements for individual colors can vary depending on a printed job, density targets for process colors (yellow, magenta/red, cyan/blue/and black) are established as: Yellow-0.95-1.05, Magenta-1.30-1.40, Cyan-1.40-1.50, & Black 1.65-1.75.

Proofing machines such as the Prufbau are usually used to simulate printing. Several aspects of this simulation are typically evaluated. A standard volume of the ink is first applied onto the distribution roller and subjected to rigorous distribution at a given speed for a given period of time. The test protocol calls for 30 sec of distribution. In this time, the ink has to be converted into the uniform, evenly distributed layer on the top of the form roller. This roller is than transferred into the printing unit, and a print is produced with 800 N printing pressure at 3 m/s speed of the substrate carrier movement. The Print is UV or EB cured and print density is recorded. A well designed ink should produce a uniform image with target density.

Additional tests that are performed with all inks in the lab would be tack and tack stability measurements. The target tack for the inks of the present invention is in the range between 20 and 21 at 1200 rpm. An inkometer is used to determine tack (Electronic Inkometer from Thwing Albert). The ink is distributed for 1 min between 3 rollers and then the measurement is taken. Since the ink delivery system on the press can contain up to 13 distribution rollers, tack stability is very important. The main benefit of the energy curable inks is that they are extremely stable on rollers since no loss of solvent or water takes place. Ideally, the inks of the present invention should have no more than a 1 point change in tack when submitted to the 10 min tack stability test (same 1200 rpm).

Ink Preparation

Inks of the present invention are formulated by mixing the component ingredients together until a uniform mixture is obtained. This mixture is then ground on a 3 roll mill until the proper grinding specification is achieved (typically in 2-3 passes on the mill). The ink may be adjusted to the proper tack with a monomer if needed.

The invention is illustrated by the following examples. The examples are merely illustrative and do not in any way limit the scope of the invention as described and claimed.

### EXAMPLE 1

An EB curable, water washable printing ink useful in the waterless lithographic printing process was formulated as follows:

| | |
|---|---|
| Yellow pigment (supplied by Sun Chemical Corp) | 17% |
| Additives (stabilizers, antimisting compounds) | 5% |
| Varnish | 78% |
| Total: | 100% |

Wherein, the composition of the varnish identified above is as follows:

| Water soluble part: | | |
|---|---|---|
| Laromer 8765 (from BASF) | 41 | parts |
| Polyethylene glycol diacrylate | 13 | parts |
| (from Sartomer Co.) | | |
| Sub Total: | 54 | parts |
| Water insoluble part: | | |
| Di-pentaerithrytol tetraacrylate | 17 | parts |
| (from Sartomer) | | |
| PO NPGDA | 11 | parts |
| (from Cognis) | | |
| Sub Total: | 28 | parts |
| Acid functional resin: | | |
| Johncryl 680 | 18 | parts |
| (from Johnson Polymer) | | |
| Total | 100 | parts |

This ink was printed using a Prufbau proofing machine to 1.08 print density and EB cured with the AEB electron beam processor set at 110 kV and 3 Mrads. The ink proof was than tested for water resistance by rubbing the printed surface with wet Q-tips. This ink film required more than 32 double rubs before any detrimental effect of wet rubbing could be seen on the print surface.

The ink tack was measured as indicated above and was found to be in the range of 20 to 21 at 1200 rpm with less than 1 point change in tack when submitted to the 10 min tack stability test described above.

Uncured ink was easily washed off the ink and printing rollers of the proofing machine with a water solution having pH of 8.5.

### EXAMPLE 2

An EB curable, water washable printing ink was formulated as described in Example 1, however the pigment was Pigment red 23 (supplied by Sun Chemical Corporation).

This ink was printed using a Prufbau proofing machine to 1.50 print density with an AEB electron beam processor set at 110 kV and 3 Mrads. The ink proof was then tested for water resistance by rubbing the printed surface with wet Q-tips. The ink film would required more than 30 double rubs before any detrimental effect of wet rubbing could be seen on the print surface.

The ink tack was measured as indicated above and was found to be in the range of 20 to 21 at 1200 rpm with less than 1 point change in tack when submitted to the 10 min tack stability test described above.

Uncured ink was easily washed off the ink and printing rollers of the proofing machine with a water solution having pH of 8.5.

### EXAMPLE 3

A UV curable, water washable printing ink was formulated as follows:

| | |
|---|---|
| Yellow pigment (supplied by Sun Chemical Corp) | 17% |
| Additives (stabilizers, antimisting compounds) | 5% |
| Photoinitiator package | 8% |
| Varnish | 70% |
| Total: | 100% |

Wherein, the composition of the varnish identified above is as follows:

| Water soluble part: | | |
|---|---|---|
| Laromer 8765 (from BASF) | 41 | parts |
| Polyethylene glycol diacrylate | 13 | parts |
| (from Sartomer Co.) | | |
| Sub Total: | 54 | parts |
| Water insoluble part: | | |
| Di-pentaerithrytol tetraacrylate | 17 | parts |
| (from Sartomer) | | |
| PO NPGDA | 11 | parts |
| (from Cognis) | | |
| Sub Total: | 28 | parts |
| Acid functional resin: | | |
| Johncryl 680 | 18 | parts |
| (from Johnson Polymer) | | |
| Total | 100 | parts |

This ink was printed using a Prufbau proofing machine to 1.45 print density and UV cured using laboratory UV curing unit having two medium pressure mercury lamp set at 200 watt/inch each and moving belt set at 200 fpm. The ink proof was then tested for water resistance by rubbing the printed surface with wet Q-tips. This ink would required more than 40 double rubs before any detrimental effect of wet rubbing could be seen on the print surface.

The ink tack was measured as indicated above and was found to be in the range of 20 to 21 at 1200 rpm with less than 1 point change in tack when submitted to the 10 min tack stability test described above.

Uncured ink was easily washed off the ink and printing rollers of the proofing machine with a water solution having pH of 8.5.

### EXAMPLE 4

A UV curable, water washable printing ink was formulated as described in Example 3 but with Pigment Black 250 (obtained from Degussa).

This ink was printed using a Prufbau proofing machine to 1.70 print density and UV cured using a laboratory UV curing unit having two medium pressure mercury lamp set at 200 watt/inch each and moving belt set at 200 fpm. The ink proof was then tested for water resistance by rubbing the printed surface with wet Q-tips. This ink would required more than 20 double rubs before any detrimental effect of wet rubbing could be seen on the print surface.

The ink tack was measured as indicated above and was found to be in the range of 20 to 21 at 1200 rpm with less than 1 point change in tack when submitted to the 10 min tack stability test described above.

Uncured ink was easily washed off the ink and printing rollers of the proofing machine with a water solution having pH of 8.5.

### EXAMPLE 5

An EB curable, water washable printing ink was prepared according to Example 1 but instead of non-reactive acid functional resin, Sarbax resin from Sartomer, ethylenically unsaturated with acid functionality was used in the ink varnish:

The varnish composition is as follows:

| Water soluble part: | | |
|---|---|---|
| Laromer 8765 (from BASF) | 41 | parts |
| Polyethylene glycol diacrylate | 13 | parts |
| (from Sartomer Co.) | | |
| Sub Total: | 54 | parts |
| Water insoluble part: | | |
| Di-pentaerithrytol tetraacrylate | 14 | parts |
| (from Sartomer) | | |
| PO NPGDA | 8 | parts |
| (from Cognis) | | |
| Sub Total: | 22 | parts |
| Acid functional ethylenically | | |
| unsaturated resin: | | |
| Johncryl 680 | 24 | parts |
| (from Johnson Polymer) | | |
| Total | 100 | parts |

This ink was printed using a Prufbau proofing machine to 1.08 print density with AEB electron beam processor set at 110 kV and 3 Mrads. The ink proof was than tested for water resistance by rubbing the printed surface with wet Q-tips. The ink would required more than 21 double rubs before any detrimental effect of wet rubbing could be seen on the print surface.

The ink tack was measured as indicated above and was found to be in the range of 20 to 21 at 1200 rpm with less than 1 point change in tack when submitted to the 10 min tack stability test described above.

Uncured ink was easily washed off the ink and printing rollers of the proofing machine with a water solution having pH of 8.5.

### EXAMPLE 6

An EB curable, water washable printing ink was formulated as follows:

| | |
|---|---|
| Yellow pigment (supplied by Sun Chemical Corp.) | 17% |
| Additives (stabilizers, antimisting compounds) | 5% |
| Varnish | 78% |
| Total: | 100% |

The composition varnish composition is as follows:

| Water soluble part: | | |
|---|---|---|
| Laromer 8765 (from BASF) | 41 | parts |
| Polyethylene glycol diacrylate | 13 | parts |
| (from Sartomer Co.) | | |
| Sub Total: | 54 | parts |
| Water insoluble part: | | |
| Di-pentaerithrytol tetraacrylate | 17 | parts |
| (from Sartomer) | | |
| PO NPGDA | 22 | parts |
| (from Cognis) | | |
| Sub Total: | 39 | parts |
| Water soluble non-reactive resin: | | |
| Polyvinylpyralidone | 7 | parts |
| (PVP 30) (from BASF) | | |
| Total | 100 | parts |

This ink was printed using a Prufbau proofing machine to 1.1 print density and EB cured with the AEB electron beam processor set at 110 kV and 3 Mrads. The ink proof was than tested for water resistance by rubbing the printed surface with wet Q-tips. The ink film required more than 30 double rubs before any detrimental effect of wet rubbing could be seen on the print surface.

The ink tack was measured as indicated above and was found to be in the range of 20 to 21 at 1200 rpm with less than 1 point change in tack when submitted to the 10 min tack stability test described above.

Uncured ink was easily washed off the ink and printing rollers of the proofing machine with a water solution having pH of 7.0.

The invention has been described in terms of preferred embodiments thereof, but is more broadly applicable as will be understood by those skilled in the art. The scope of the invention is only limited by the following claims.

What is claimed is:

1. A single phase, energy curable varnish composition comprising:
(a) water soluble ethylenically unsaturated reactive oligomers and monomers;
(b) water insoluble ethylenically unsaturated reactive oligomers and monomers; and
(c) a resin selected from the group consisting of a water soluble non-reactive resin, a water insoluble acid or base functional resin and water insoluble ethylenically unsaturated reactive resin, wherein said water insoluble resins contain acid functional groups.

2. The varnish composition of claim 1, wherein the amount of water soluble ethylenically unsaturated reactive oligomers and monomers present is between 30 and 85 parts.

3. The varnish composition of claim 1, wherein the amount of water insoluble ethylenically unsaturated reactive oligomers and monomers is between 10 and 45 parts.

4. The varnish composition of claim 1, wherein the amount of the acid functional groups in the water insoluble resins is about 5 to 25 parts.

5. The varnish composition of claim 1 when present in a lithographic printing ink composition, renders the ink composition water washable before curing and water resistant after curing.

6. The varnish composition of claim 1, wherein the water soluble oligomer is selected from the group consisting of an acrylate oligomer, a methacrylate oligomer and a combination thereof.

7. The varnish composition of claim 6, wherein the acrylate oligomer is selected from the group consisting of epoxy acrylate, epoxy methacrylate, polyether acrylate, polyether methacrylate, polyester acrylate, polyester mathacrylate, polyurethane acrylate, polyurethane methacrylate, melamine acrylate, melamine methacrylate, polyethylene glycol diacrylate and polyethylene glycol dimethacrylate oligomers.

8. The varnish composition of claim 1, wherein the water soluble oligomer contains two or more acrylate oligomer groups or methacrylate oligomer groups.

9. The varnish composition of claim 8, wherein the acrylate and methacrylate oligomers are epoxy acrylate and epoxy methacrylate oligomers, respectively.

10. The varnish composition of claim 1, wherein the water soluble, ethylenically unsaturated oligomer contains carboxylic acid groups, acrylic groups, methacrylic groups, polyamide resins, acrylic resins, acrylated acrylic resins, amino resins, polyester resins, urethane resins, starch, polysulfonate resins, phenolic resins and melamine resins or a combination thereof.

11. The varnish composition of claim 1, wherein the water insoluble ethylenically unsaturated oligomer contains aromatic resins, phenol formaldehyde resins, melamine resins, hydrocarbon resins and rosins, or a combination thereof.

12. An energy curable, water washable printing ink composition suitable for waterless lithographic printing comprising:
(a) water soluble ethylenically unsaturated reactive oligomers and monomers;
(b) water insoluble ethylenically unsaturated reactive oligomers and monomers;
(c) a resin selected from the group consisting of a water soluble non-reactive resin, a water insoluble acid or base functional resin and water insoluble ethylenically unsaturated reactive resin, wherein said water insoluble resins contain acid functional groups; and
(d) a pigment.
wherein said printing ink composition is water washable before curing and water-resistant after curing.

13. The printing ink composition of claim 12, wherein the amount of water soluble ethylenically unsaturated reactive oligomers and monomers present is between 30 and 85 parts.

14. The printing ink composition of claim 12, wherein the amount of water insoluble ethylenically unsaturated reactive oligomers and monomers is between 10 and 45 parts.

15. The printing ink composition of claim 12, wherein the amount of the acid functional groups in the water insoluble resins is about 5 to 25 parts.

16. The printing ink composition of claim 12 being water washable before curing and water resistant after curing.

17. The printing ink composition of claim 12, wherein the pigment is selected from the group consisting of monoazo yellow, monoarylide yellow, diarylide yellow, naphthol red, rubine red, lithol rubine, phtalocyanine blue, carbon black, Pigment Yellow 1, Pigment Yellow 3, Pigment Yellow 12, Pigment Yellow 13, Pigment Yellow 14, Pigment Yellow 17, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment Yellow 126, Pigment Yellow 127, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 57:1, Pigment Red 112, Pigment Red 170, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment violet 23, Pigment Black 7, and Clariant® GDR Pigment Yellow 11-025.

19. An energy curable, water washable printing ink composition suitable for waterless lithographic printing comprising:
(a) between about 30 and 85 parts of a water soluble ethylenically unsaturated reactive oligomers and monomers;
(b) between about 10 and 45 parts of a water insoluble ethylenically unsaturated reactive oligomers and monomers;
(c) a resin selected from the group consisting of a water soluble non-reactive resin, a water insoluble acid or base functional resin and water insoluble ethylenically unsaturated reactive resin, wherein said resin contains between about 5 to 25 parts of acid functional groups; and
(d) a pigment.
wherein said printing ink composition is water washable before curing and water-resistant after curing.

20. A method of preparing an energy curable, water washable printing ink composition suitable for the waterless lithographic printing comprising mixing:
(a) water soluble ethylenically unsaturated reactive oligomers and monomers;
(b) water insoluble ethylenically unsaturated reactive oligomers and monomers;
(c) a resin selected from the group consisting of a water soluble non-reactive resin, a water insoluble acid or base functional resin and water insoluble ethylenically unsaturated reactive resin, wherein said water insoluble resins contain acid functional groups; and
(d) a pigment.
wherein said printing ink composition is water washable before curing and water-resistant after curing.

21. A method of preparing an energy curable, water washable printing ink composition suitable for the waterless lithographic printing comprising mixing:
(a) between about 30 and 85 parts of a water soluble ethylenically unsaturated reactive oligomers and monomers;
(b) between about 10 and 45 parts of a water insoluble ethylenically unsaturated reactive oligomers and monomers;
(c) a resin selected from the group consisting of a water soluble non-reactive resin, a water insoluble acid or base functional resin and water insoluble ethylenically unsaturated reactive resin, wherein said water insoluble resins contain between about 5 to 25 parts of acid functional groups; and
(d) a pigment
wherein said printing ink composition is water washable before curing and water-resistant after curing.

22. A method of waterless lithographic printing comprising using an energy curable, water washable printing ink composition which comprises:
(a) water soluble ethylenically unsaturated reactive oligomers and monomers;
(b) water insoluble ethylenically unsaturated reactive oligomers and monomers;
(c) a resin selected from the group consisting of a water soluble non-reactive resin, a water insoluble acid or base functional resin and water insoluble ethylenically unsaturated reactive resin, wherein said water insoluble resins contain acid functional groups; and
(d) a pigment.
wherein said printing ink composition is water washable before curing and water-resistant after curing.

23. A method of waterless lithographic printing comprising using an energy curable, water washable, printing ink composition which comprises:
(a) between about 30 and 85 parts of a water soluble ethylenically unsaturated reactive oligomers and monomers;
(b) between about 10 and 45 parts of a water insoluble ethylenically unsaturated reactive oligomers and monomers;
(c) a resin selected from the group consisting of a water soluble non-reactive resin, a water insoluble acid or base functional resin and water insoluble ethylenically unsaturated reactive resin, wherein said water insoluble resins contain between about 5 to 25 parts of acid functional groups; and
(d) a pigment
wherein said printing ink composition is water washable before curing and water-resistant after curing.
